(19) United States
(12) Patent Application Publication
(10) Pub. No.: US 2025/0315298 A1
(43) Pub. Date: Oct. 9, 2025

(54) COMPUTE RESOURCE ALLOCATION FOR CHANNEL LOGIN ACTIVITY

(71) Applicant: INTERNATIONAL BUSINESS MACHINES CORPORATION, ARMONK, NY (US)

(72) Inventors: PASQUALE A. CATALANO, WALLKILL, NY (US); JOHN S. WERNER, FISHKILL, NY (US); ARKADIY O. TSFASMAN, WAPPINGERS FALLS, NY (US); ANDREW GERALD CRIMMINS, MONTROSE, NY (US)

(21) Appl. No.: 18/625,805

(22) Filed: Apr. 3, 2024

(51) Int. Cl. G06F 9/50

(52) U.S. Cl. CPC G06F 9/5027

(57) ABSTRACT

Compute resource allocation for channel login activity includes detecting a start of channel login activity. A number of channels anticipated to login during the channel login activity is identified. Based on the identified number of channels, an anticipated number of processor cores in a plurality of processor cores of an input/output subsystem to be allocated to be able to handle the channel login activity is predicted. The predicted number of processor cores is allocated to handle the channel login activity.

### BACKGROUND

The present disclosure relates to methods, apparatus, and products for compute resource allocation for channel login activity.

### SUMMARY

According to embodiments of the present disclosure, various methods, apparatus and products for compute resource allocation for channel login activity are described herein. In some aspects, compute resource allocation for channel login activity includes detecting a start of channel login activity. A number of channels anticipated to login during the channel login activity is identified. Based on the identified number of channels, an anticipated number of processor cores in a plurality of processor cores of an input/output subsystem to be allocated to be able to handle the channel login activity is predicted. The predicted number of processor cores is allocated to handle the channel login activity.

### BRIEF DESCRIPTION OF THE DRAWINGS

FIG. 1 sets forth an example computing environment according to aspects of the present disclosure.

FIG. 2 sets forth an example system for compute resource allocation for channel login activity according to aspects of the present disclosure.

FIG. 3 sets forth a flowchart of an example method for compute resource allocation for channel login activity according to aspects of the present disclosure.

### DETAILED DESCRIPTION

Some examples disclosed herein may be utilized by systems where there is a choice of multiple paths, or channels, to drive an input/output (I/O) to a storage subsystem, or storage array. In some configurations, there may be up to eight channels, for example, that an I/O operation can be driven down, also known as a path group. Examples of the present disclosure can be utilized with various I/O interfaces for connecting servers to storage devices including Fiber Connection, Fiber Channel, Ethernet, Remote Direct Memory Access (RDMA), Non-Volatile Memory Express (NVMe), and Peripheral Component Interconnect Express (PCIe).

During normal operation of a switched fabric network, devices connect to network components, such as switches, using a login message with a payload that describes supported communication parameters and other such information. The network component can verify whether the current network policies support the capabilities of devices attempting to establish communication. One example of a switched fabric network can include a storage area network (SAN), where a host or other device communicates through one or more switches to connected devices, such as control units of storage arrays. SAN environments allow for communication between a computer system and the SAN. The SAN can be off-device storage that the computer system can access, without storing an excess of data on the computer system. Within some SAN environments, a network of computer systems are connected to the SAN environment which can host both servers and storage. A SAN can be configured to connect users to data stored on another system. For the user to access the data, the user can connect to a server. The server can communicate with a series of storage units through a switch. The storage units can contain the data that the user wants to access. The switch connects servers to storage units within the SAN.

In SAN environments, host to target access may be based on zoning setup and host to target login, fabric login (FLOGI), or port login (PLOGI). In some examples, as a device initiates a connection to a switched fabric network, the device can incorporate an indication of communication capabilities in a fabric login payload of a fabric login request (FLOGI). A fabric login request can identify multiple connection aspects, such as identifying ports and exchanging buffer credits for flow control through a network device, such as a switch. A fabric login payload can include a plurality of fabric login parameters. For example, the fabric login payload may include common service parameters, port name, node switch fabric name, and other such values. The common service parameters can include configuration information, such as buffer-to-buffer credits, common features, buffer-to-buffer state change number, buffer-to-buffer receive data field size, and other such parameters.

Based on receipt of a fabric login request, the requesting port can be assigned an address and receive a set of service parameters specifying the port name of the switch port, the fabric name, and the fabric's capabilities. Capability information can include attributes such as fiber channel classes of services that are supported, and features that are supported by the SAN fabric. After processing of a fabric login request has completed, an acknowledgment of completion of processing of the FLOGI request may be sent back to the requesting port.

Handling of channel login activity, including PLOGI and FLOGI requests, can be processor intensive. After initial machine load (IML) of a system, multiple channels may login at the same time, which causes a spike in I/O processing compute. If adequate resources are not available to handle the login activity, the process may be extended and delays in handling other I/O tasks may occur. Similarly, after the login activity has concluded, if compute resources remain allocated to handling login activity, compute resources are wasted as such compute resources could be more effectively used to accomplish other I/O tasks. Some examples disclosed herein dynamically provide more processing power to login procedures, and allocate more compute resources to domains with more channels. This saves time because channel login can be completed at the same time as other activities. It also saves time because the window for channel login is smaller due to all channels logging in simultaneously, making them available to the operating systems sooner. Some examples allow a system to come back from a system outage much faster, by temporarily allocating resources needed during the most stressful periods of channel login activity.

Some examples disclosed herein are directed to compute resource allocation during increased channel login activity. In some examples, compute resources are redistributed to the I/O subsystem at IML time during increased channel login activity, and then are redistributed for normal operation. Some examples include detecting the start of channel login, and extracting the number of channels that will need to login. Some examples further include identifying the availability of all I/O processors. Some examples further include predicting, based on configuration information, the amount of central processing unit (CPU) resources (e.g., core count, cache, etc.) required for the given number of channel logins, and allocating the predicted CPU resources for channel login (e.g., spare resources and/or resources that are currently being used for other activity such as adapter initialization, and other IML activity). Some examples further include measuring login activity, and, after login completes, returning resources to their original state/allocation. Some examples further include utilizing an artificial intelligence (AI) engine on a CPU for unsupervised learning data, including number of channels, number of allocated resources, duration of the login window, utilization of resources during the login window. Some examples further include sending “home” (e.g., sending to a centralized server communicatively coupled to multiple systems handling channel logins) data for improved model training for resource prediction on the other systems.

An example of the present disclosure is directed to a method for compute resource allocation for channel login activity, which includes detecting a start of channel login activity. The method includes identifying a number of channels anticipated to login during the channel login activity. The method includes predicting, based on the identified number of channels, an anticipated number of processor cores in a plurality of processor cores of an input/output subsystem to be allocated to be able to handle the channel login activity. The method includes allocating the predicted number of processor cores to handle the channel login activity.

Examples of the method include various technical features that yield technical effects that provide various improvements to computer technology. For instance, some examples include the technical features of identifying a number of channels anticipated to login during the channel login activity, and predicting, based on the identified number of channels, an anticipated number of processor cores in a plurality of processor cores of an input/output subsystem to be allocated to be able to handle the channel login activity. These technical features yield the technical effect of dynamically providing more processing power to login procedures, which allows all channels to login simultaneously, reduces the window for channel login, and makes the channels available to the operating systems sooner. A system may come back from a system outage much faster, by temporarily allocating additional resources during the most stressful periods of channel login activity.

In some examples of the method, allocating the predicted number of processor cores includes allocating one or more spare processor cores. In some examples of the method, allocating the predicted number of processor cores includes allocating one or more processor cores currently engaged in input/output activities other than the channel login activity.

Some examples of the method further include monitoring the channel login activity; and deallocating, based on the monitoring, one or more of the allocated number of processor cores from the channel login activity. In some examples of the method, the one or more of the allocated number of processor cores are deallocated in response to a threshold number of the channels completing login.

Some examples of the method further include generating, by an artificial intelligence engine based on the handling of the channel login activity, learning data; and training, based on the learning data, a model for predicting the anticipated number of processor cores for future channel login activity. Some examples of the method may further include sending the learning data to a centralized system to be used in training multiple server systems in handling other channel login activity.

Another example of the present disclosure is directed to a system for compute resource allocation for channel login activity, which includes an input/output subsystem including a plurality of processor cores. The system includes an input/output management processor to execute a plurality of instructions to: detect a start of channel login activity; identify a number of channels anticipated to login during the channel login activity; predict, based on the identified number of channels, an anticipated number of the processor cores to be allocated to be able to handle the channel login activity; and allocate the predicted number of processor cores to handle the channel login activity.

Examples of the system include various technical features that yield technical effects that provide various improvements to computer technology. For instance, some examples include the technical features of identifying a number of channels anticipated to login during the channel login activity, and predicting, based on the identified number of channels, an anticipated number of the processor cores to be allocated to be able to handle the channel login activity. These technical features yield the technical effect of dynamically providing more processing power to login procedures, which allows all channels to login simultaneously, reduces the window for channel login, and makes the channels available to the operating systems sooner. A system may come back from a system outage much faster, by temporarily allocating additional resources during the most stressful periods of channel login activity.

In some examples of the system, allocating the predicted number of processor cores includes allocating one or more spare processor cores. In some examples of the system, allocating the predicted number of processor cores includes allocating one or more processor cores currently engaged in input/output activities other than the channel login activity.

In some examples of the system, the input/output management processor is to execute the plurality of instructions to: monitor the channel login activity; and deallocate, based on the monitoring, one or more of the allocated number of processor cores from the channel login activity. In some examples of the system, the one or more of the allocated number of processor cores are deallocated in response to a threshold number of the channels completing login.

In some examples of the system, the input/output management processor is to execute the plurality of instructions to: generate, by an artificial intelligence engine based on the handling of the channel login activity, learning data; and train, based on the learning data, a model for predicting the anticipated number of processor cores for future channel login activity. In some examples of the system, the input/output management processor is to execute the plurality of instructions to send the learning data to a centralized system to be used in training multiple server systems in handling other channel login activity.

Another example of the present disclosure is directed to a computer program product comprising a computer readable storage medium. The computer readable storage medium comprises computer program instructions that, when executed: detect a start of channel login activity; identify a number of channels anticipated to login during the channel login activity; predict, based on the identified number of channels, an anticipated number of processor cores in a plurality of processor cores of an input/output subsystem to be allocated to be able to handle the channel login activity; and allocate the predicted number of processor cores to handle the channel login activity.

Examples of the computer program product include various technical features that yield technical effects that provide various improvements to computer technology. For instance, some examples include the technical features of identifying a number of channels anticipated to login during the channel login activity, and predicting, based on the identified number of channels, an anticipated number of processor cores in a plurality of processor cores of an input/output subsystem to be allocated to be able to handle the channel login activity. These technical features yield the technical effect of dynamically providing more processing power to login procedures, which allows all channels to login simultaneously, reduces the window for channel login, and makes the channels available to the operating systems sooner. A system may come back from a system outage much faster, by temporarily allocating additional resources during the most stressful periods of channel login activity.

In some examples of the computer program product, allocating the predicted number of processor cores includes allocating one or more spare processor cores. In some examples of the computer program product, allocating the predicted number of processor cores includes allocating one or more processor cores currently engaged in input/output activities other than the channel login activity.

In some examples of the computer program product, the computer readable storage medium further comprises computer program instructions that, when executed: monitor the channel login activity; and deallocate, based on the monitoring, one or more of the allocated number of processor cores from the channel login activity. In some examples of the computer program product, the one or more of the allocated number of processor cores are deallocated in response to a threshold number of the channels completing login.

In some examples of the computer program product, the computer readable storage medium further comprises computer program instructions that, when executed: generate, by an artificial intelligence engine based on the handling of the channel login activity, learning data; train, based on the learning data, a model for predicting the anticipated number of processor cores for future channel login activity; and send the learning data to a centralized system to be used in training multiple server systems in handling other channel login activity.

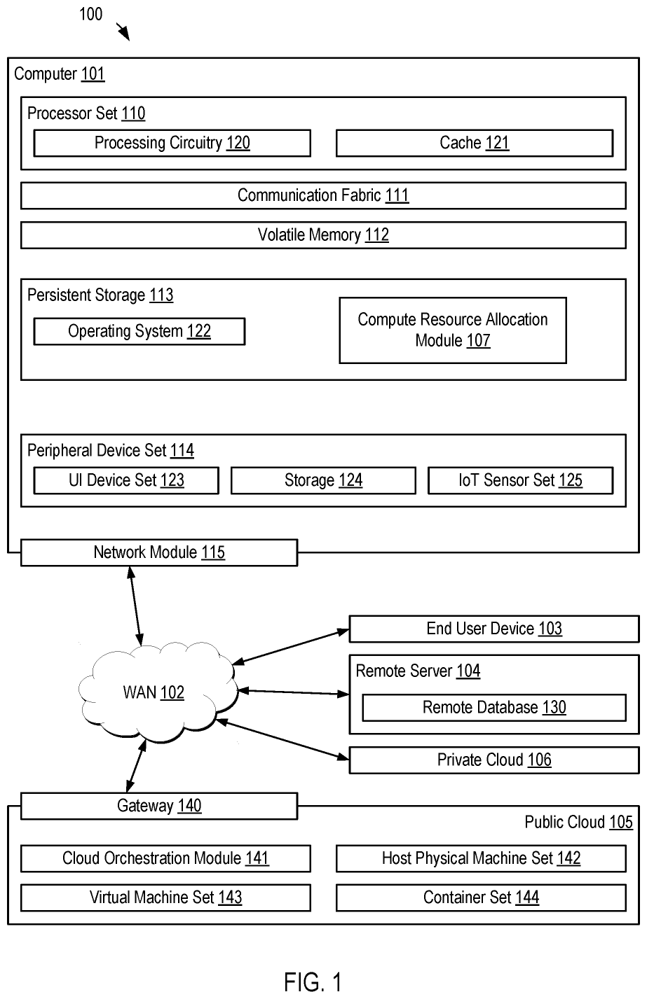

FIG. 1 sets forth an example computing environment 100 according to aspects of the present disclosure. Computing environment 100 contains an example of an environment for the execution of at least some of the computer code involved in performing the various methods described herein, such as compute resource allocation module 107. In addition to compute resource allocation module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and compute resource allocation module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in compute resource allocation module 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in compute resource allocation module 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

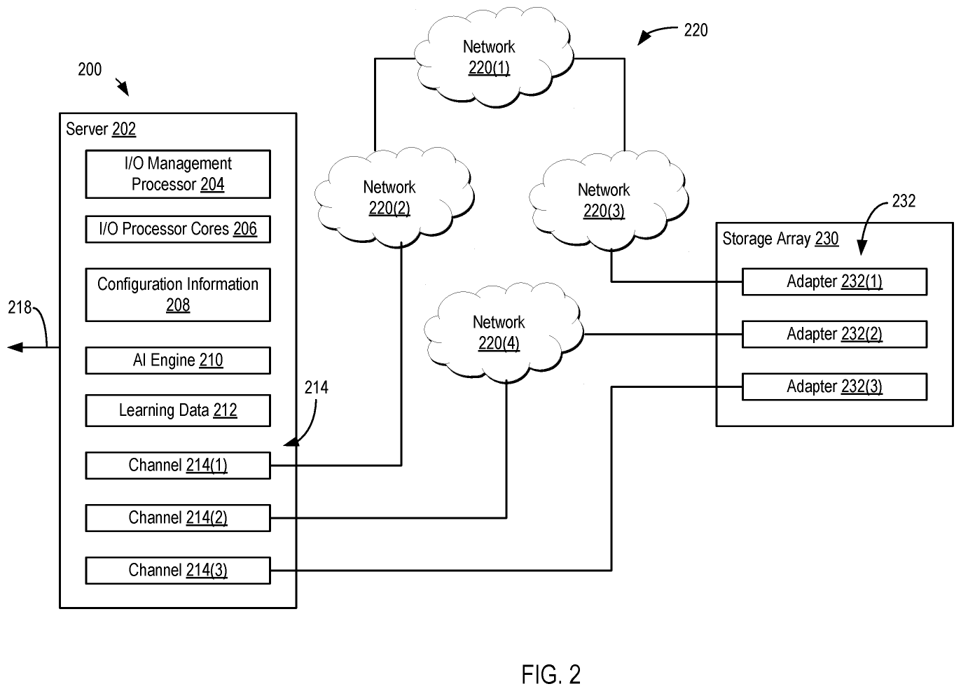

FIG. 2 sets forth an example system 200 for compute resource allocation for channel login activity according to aspects of the present disclosure. System 200 includes server 202, networks 220(1)-220(4) (collectively referred to as networks 220), and storage array 230. At least a portion of the server 202 and/or the storage array 230 may be implemented by at least a portion of computing environment 100 (FIG. 1). The functions of compute resource allocation module 107 (FIG. 1) may be performed by elements of the server 202. The networks 220 may be used to couple the server 202 to the storage array 230 for processing I/O operations. The networks 220 may be implemented using any one or more short range or long range wired or wireless networks. Each of the networks 220 may be implemented using different network technologies, or two or more of the networks 220 may be implemented using the same network technology.

Server 202 includes I/O management processor 204, I/O processor cores 206, configuration information 208, AI engine 210, learning data 212, and I/O channels 214(1)-214(3) (collectively referred to as channels 214). The channels 214 are used to drive execution of an I/O operation at storage array 230. Storage array 230 includes adapters 232(1)-232(3) (collectively referred to as adapters 232). A storage array, such as storage array 230, may include storage devices (not shown) and additional software and/or hardware for performing I/O operations (e.g., reads, writes) to data located in the storage devices. The adapters 232 may receive the I/O operations and transmit them to a controller (not shown) of the storage array 230 that performs the requested I/O operations.

As shown in FIG. 2, channel 214(1) traverses three networks (i.e., network 220(2), network 220(1), and network 220(3)) to reach adapter 232(1) of storage array 230. Channel 214(2) traverses one network (i.e., network 220(4)) to reach adapter 232(2) of storage array 230. Channel 214(3) is directly connected to adapter 232(3) of storage array 230 via, for example, a cable or other physical connector. For ease of description, FIG. 2 shows three channels 214 on server 202. In other examples, server 202 may include eight or sixteen or hundreds or thousands of channels connecting to storage array 230 and/or to one or more other servers or storage arrays (not shown). Also, for ease of description, FIG. 2 shows three adapters 232 on storage array 230. In other examples, storage array 230 may include eight or sixteen or hundreds or thousands of adapters connecting to server 202 and/or to one or more other servers or storage arrays (not shown).

In some examples, server 202 performs compute resource allocation for I/O channel login activity of channels 214. The channel login activity may include, for example, the handling of fabric login (FLOGI) and/or port login (PLOGI) requests. The process may begin, for example, by I/O management processor 204 detecting a start of channel login activity, such as during IML. I/O management processor 204 identifies a number of the channels 214 anticipated to login during the channel login activity. In some examples, I/O management processor 204 may use stored configuration information 208 regarding the channels 214 to facilitate the identification of the number of channels 214 anticipated to login.

In some examples, I/O management processor 204 may then interact with AI engine 210 to predict, based on the identified number of channels 214, an anticipated number of I/O processor cores in the plurality of I/O processor cores 206 of an input/output subsystem to be allocated to be able to handle the channel login activity. I/O management processor 204 then allocates the predicted number of I/O processor cores 206 to handle the channel login activity. In some examples, I/O management processor 204 may allocate all of the I/O processor cores 206 to handle the channel login activity, such as during IML. In other examples, there may be less channel login activity and I/O management processor 204 may allocate a lesser number of I/O processor cores 206 in an amount proportional to the channel login activity. I/O management processor 204 may continually adjust the number of I/O processor cores 206 currently allocated to channel login activity based on the current volume of channel login activity.

In some examples, the I/O processor cores 206 may include one or more spare I/O processor cores that are intended to be used in the event of failure of one or more of the other I/O processor cores 206. In some of those examples, the allocation of the predicted number of I/O processor cores 206 performed by I/O management processor 204 may include allocating one or more spare ones of the I/O processor cores 206. In some examples, the I/O processor cores 206 may include one or more I/O processor cores that, at the start of the login activity, may already have been allocated to handle input/output activities other than login activity. In some of those examples, the allocation of the predicted number of I/O processor cores 206 performed by I/O management processor 204 may include allocating one or more I/O processor cores 206 currently engaged in input/output activities other than the channel login activity.

I/O management processor 204 monitors the channel login activity and keeps track of the number of channels 214 that have completed the login process. I/O management processor 204 deallocates, based on the monitoring, one or more of the allocated number of I/O processor cores 206 from the login activity. In some examples, the one or more of the allocated number of I/O processor cores 206 are deallocated by I/O management processor 204 in response to a threshold number of the channels 214 completing login. As an example, the threshold may be 100 percent of the channels 214, so that once all of the channels 214 have completed login, all of the allocated I/O processor cores 206 are deallocated from the login activity and are then free to handle other I/O tasks or return to a spare status. In other examples, there may be multiple thresholds, and the number of I/O processor cores 206 allocated to the channel login activity may be gradually decreased over time based on the multiple thresholds.

In some examples, AI engine 210 includes a model for performing the prediction of the anticipated number of I/O processor cores 206 to handle the current channel login activity, and generates learning data 212 based on the handling of the channel login activity. In some examples, the learning data 212 may include number of channels 214, number of allocated resources (e.g., number of allocated I/O processor cores 206), duration of the login window, and utilization of resources during the login window. In some examples, the model for predicting the anticipated number of I/O processor cores 206 is trained by the AI engine 210 for future channel login activity based on the learning data 212. In some examples, server 202 sends the learning data 212 to a centralized system via communication link 218 to be used in training or updating multiple server systems in handling other channel login activity.

Examples of system 200 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various examples. Some examples of system 200 may include fewer or additional components than shown in FIG. 2, and the components may be arranged differently than shown in FIG. 2.

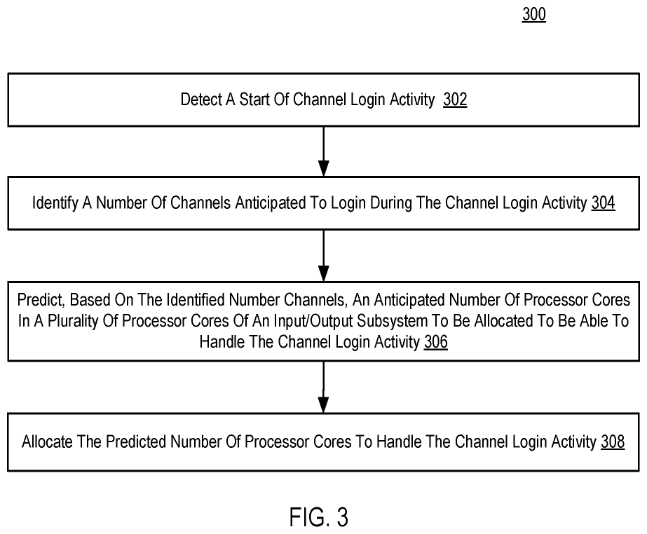

FIG. 3 sets forth a flowchart of an example method 300 for compute resource allocation for channel login activity according to aspects of the present disclosure. In a particular embodiment, the method 300 is performed utilizing compute resource allocation module 107 (FIG. 1) and server 202 (FIG. 2). The method 300 includes detecting 302 a start of channel login activity. The method 300 includes identifying 304 a number of channels anticipated to login during the channel login activity. The method 300 includes predicting 306, based on the identified number of channels, an anticipated number of processor cores in a plurality of processor cores of an input/output subsystem to be allocated to be able to handle the channel login activity. The method 300 includes allocating 308 the predicted number of processor cores to handle the channel login activity.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for compute resource allocation for channel login activity, comprising:
detecting a start of channel login activity;
identifying a number of channels anticipated to login during the channel login activity;
predicting, based on the identified number of channels, an anticipated number of processor cores in a plurality of processor cores of an input/output subsystem to be allocated to be able to handle the channel login activity; and
allocating the predicted number of processor cores to handle the channel login activity.

2. The method of claim 1, wherein allocating the predicted number of processor cores includes allocating one or more spare processor cores.

3. The method of claim 1, wherein allocating the predicted number of processor cores includes allocating one or more processor cores currently engaged in input/output activities other than the channel login activity.

4. The method of claim 1, and further comprising:
monitoring the channel login activity; and
deallocating, based on the monitoring, one or more of the allocated number of processor cores from the channel login activity.

5. The method of claim 4, wherein the one or more of the allocated number of processor cores are deallocated in response to a threshold number of the channels completing login.

6. The method of claim 1, and further comprising:
generating, by an artificial intelligence engine based on the handling of the channel login activity, learning data; and
training, based on the learning data, a model for predicting the anticipated number of processor cores for future channel login activity.

7. The method of claim 6, and further comprising:
sending the learning data to a centralized system to be used in training multiple server systems in handling other channel login activity.

8. A system for compute resource allocation for channel login activity, comprising:
an input/output subsystem including a plurality of processor cores; and
an input/output management processor to execute a plurality of instructions to:
detect a start of channel login activity;
identify a number of channels anticipated to login during the channel login activity;
predict, based on the identified number of channels, an anticipated number of the processor cores to be allocated to be able to handle the channel login activity; and
allocate the predicted number of processor cores to handle the channel login activity.

9. The system of claim 8, wherein allocating the predicted number of processor cores includes allocating one or more spare processor cores.

10. The system of claim 8, wherein allocating the predicted number of processor cores includes allocating one or more processor cores currently engaged in input/output activities other than the channel login activity.

11. The system of claim 8, wherein the input/output management processor is to execute the plurality of instructions to:
monitor the channel login activity; and
deallocate, based on the monitoring, one or more of the allocated number of processor cores from the channel login activity.

12. The system of claim 11, wherein the one or more of the allocated number of processor cores are deallocated in response to a threshold number of the channels completing login.

13. The system of claim 8, wherein the input/output management processor is to execute the plurality of instructions to:
generate, by an artificial intelligence engine based on the handling of the channel login activity, learning data; and
train, based on the learning data, a model for predicting the anticipated number of processor cores for future channel login activity.

14. The system of claim 13, wherein the input/output management processor is to execute the plurality of instructions to:
send the learning data to a centralized system to be used in training multiple server systems in handling other channel login activity.

15. A computer program product comprising a computer readable storage medium, wherein the computer readable storage medium comprises computer program instructions that, when executed:
detect a start of channel login activity;
identify a number of channels anticipated to login during the channel login activity;
predict, based on the identified number of channels, an anticipated number of processor cores in a plurality of processor cores of an input/output subsystem to be allocated to be able to handle the channel login activity; and
allocate the predicted number of processor cores to handle the channel login activity.

16. The computer program product of claim 15, wherein allocating the predicted number of processor cores includes allocating one or more spare processor cores.

17. The computer program product of claim 15, wherein allocating the predicted number of processor cores includes allocating one or more processor cores currently engaged in input/output activities other than the channel login activity.

18. The computer program product of claim 15, wherein the computer readable storage medium further comprises computer program instructions that, when executed:
monitor the channel login activity; and
deallocate, based on the monitoring, one or more of the allocated number of processor cores from the channel login activity.

19. The computer program product of claim 18, wherein the one or more of the allocated number of processor cores are deallocated in response to a threshold number of the channels completing login.

20. The computer program product of claim 15, wherein the computer readable storage medium further comprises computer program instructions that, when executed:
generate, by an artificial intelligence engine based on the handling of the channel login activity, learning data;
train, based on the learning data, a model for predicting the anticipated number of processor cores for future channel login activity; and
send the learning data to a centralized system to be used in training multiple server systems in handling other channel login activity.
